(19) United States
(12) Patent Application Publication
(10) Pub. No.: US 2026/0069074 A1
(43) Pub. Date: Mar. 12, 2026

(54) COOKING APPLIANCE AND METHOD FOR CONTROLLING COOKING APPLIANCE

(71) Applicant: FOSHAN SHUNDE MIDEA ELECTRICAL HEATING APPLIANCES MANUFACTURING CO., LTD., Foshan (CN)

(72) Inventors: Hui LIAO, Foshan (CN); Guanghua LUO, Foshan (CN); Xianglong YANG, Foshan (CN); Xingguo YANG, Foshan (CN); Hualiang CHEN, Foshan (CN)

(21) Appl. No.: 19/320,104

(22) Filed: Sep. 5, 2025

(30) Foreign Application Priority Data
Sep. 6, 2024 (CN) 202422202352.7
Nov. 28, 2024 (CN) 202411729930.0

(51) Int. Cl. A47J 27/08

(52) U.S. Cl. CPC A47J 27/0802; A47J 27/0804; A47J 2202/00

(57) ABSTRACT

A cooking appliance includes a cooking container, a pressure limiting valve, and a temperature measurement device. The cooking container is provided with a working space including a cooking chamber, and a mounting chamber, an exhaust chamber, and an exhaust port that communicate with each other successively. The pressure limiting valve is located in the working space and at least partially located in the mounting chamber, and is configured to allow or cut off a communication between the mounting chamber and the cooking chamber. The temperature measurement device is at least partially located in the exhaust chamber and configured to allow a fluid in the exhaust chamber to flow to the exhaust port through the temperature measurement device. The exhaust chamber extends from the pressure limiting valve to the temperature measurement device along an arrangement direction of the pressure limiting valve and the temperature measurement device.

### CROSS-REFERENCE TO RELATED APPLICATIONS

This application claims priority to Chinese Patent Application No. 202422202352.7, filed on Sep. 6, 2024 and Chinese Patent Application No. 202411729930.0, filed on Nov. 28, 2024, the entire contents of both of which are hereby incorporated by reference.

### BACKGROUND

In a related art, it is difficult for a temperature measurement device of a cooking appliance to relatively accurately measure a temperature of steam discharged from an exhaust port of the cooking appliance. In addition, when food is cooked in a cooking chamber, it is difficult to balance both water-locked steaming of the food in the cooking chamber and determination of an amount of water of the food in the cooking chamber.

### SUMMARY

The present disclosure relates to the technical field of cooking, and more particularly to a cooking appliance and a method for controlling a cooking appliance.

In order to solve the technical problem in the related art, embodiments of the present disclosure desire to provide a cooking appliance and a method for controlling a cooking appliance, to more accurately measure a temperature of the steam discharged from an exhaust port, and to balance both the water-locked steaming of food in a cooking chamber and determination of an amount of water of the food in the cooking chamber.

The technical solutions of the embodiments of the present disclosure are achieved as follows.

A first aspect of an embodiment of the present disclosure provides a cooking appliance, including a cooking container, a pressure limiting valve and a temperature measurement device.

The cooking container is provided with a working space inside the cooking container. The working space includes a cooking chamber, a mounting chamber, an exhaust chamber and an exhaust port. The mounting chamber, the exhaust chamber and the exhaust port communicate with each other successively.

The pressure limiting valve is located in the working space, and the pressure limiting valve is at least partially located in the mounting chamber. The pressure limiting valve is configured to allow a communication between the mounting chamber and the cooking chamber or cut off a communication between the mounting chamber and the cooking chamber.

The temperature measurement device is at least partially located in the exhaust chamber, and a fluid in the exhaust chamber flows to the exhaust port through the temperature measurement device. An arrangement direction of the pressure limiting valve and the temperature measurement device is a preset direction, and the exhaust chamber extends from the pressure limiting valve to the temperature measurement device along the preset direction.

A second aspect of an embodiment of the present disclosure provides a method for controlling a cooking appliance, and the cooking appliance is the cooking appliance according to the first aspect described above. The method includes the following operations. A temperature of a target fluid is obtained in case that a pressure in the cooking chamber of the cooking appliance is greater than or equal to a pressure limiting value of the pressure limiting valve, in which the target fluid is a fluid discharged from the cooking chamber via the pressure limiting valve. A heating power of the cooking appliance is reduced to heat the cooking chamber in case that the temperature of the target fluid is greater than or equal to a first preset temperature, in which the first preset temperature is configured to determine a state of the pressure limiting valve.

### BRIEF DESCRIPTION OF THE DRAWINGS

FIG. 1 is a schematic diagram of a cooking appliance according to an embodiment of the present disclosure.

FIG. 2 is an enlarged view at A in FIG. 1.

FIG. 3 is a schematic diagram of a cooking appliance according to another embodiment of the present disclosure.

FIG. 4 is an enlarged view at B in FIG. 3.

FIG. 5 is an assembly view of a shell cover and a mounting seat.

FIG. 6 is an exploded view of a cooking appliance according to an embodiment of the present disclosure.

FIG. 7 is a schematic diagram of a valve seat according to an embodiment of the present disclosure.

FIG. 8 is a schematic diagram of a valve cover according to an embodiment of the present disclosure.

FIG. 9 is an assembly view of a shell cover and a mounting seat according to an embodiment of the present disclosure.

FIG. 10 is a schematic diagram of a cooking appliance according to an embodiment of the present disclosure, in which a pressure limiting valve is a ball valve.

FIG. 11 is a schematic flow chart of a method for controlling a cooking appliance according to an embodiment of the present disclosure.

FIG. 12 is a schematic flow chart of a method for controlling a cooking appliance according to an embodiment of the present disclosure, in which a first cooking mode is shown.

FIG. 13 is a schematic flow chart of a method for controlling a cooking appliance according to an embodiment of the present disclosure, in which a second cooking mode is shown.

FIG. 14 is a schematic flow chart of a method for controlling a cooking appliance according to an embodiment of the present disclosure, in which a third cooking mode is shown.

### LIST OF REFERENCE SYMBOLS

1. cooking container; 11. working space; 111. cooking chamber; 112. mounting chamber; 113. exhaust chamber; 114. exhaust port; 12. cooking body; 121. main body; 122. shell cover; 1221. reinforcement boss; 123. mounting seat; 1231. water blocking rib; 1232. water discharge passage; 13. container lid; 131. mounting boss; 1311. pressure limiting port; 132. restraint ring; 133. lid body; 134. flow guide casing; 2. pressure limiting valve; 21. valve seat; 211. first chamber; 2111. transition air port; 212. sealing end face; 213. air inlet hole; 22. valve cover; 221. air outlet hole; 23. valve body; 24. second chamber; 3. temperature measurement device; 31. temperature sensing component; 4. lock mechanism; 5. water storage box.

### DETAILED DESCRIPTION

In order to make the purposes, the technical solutions and the advantages of the present disclosure to be understood more clearly, the present disclosure will be further described in detail below with reference to the accompanying drawings and embodiments. It is to be understood that specific embodiments described herein are merely for illustrating the present disclosure and are not intended to limit the present disclosure.

The specific technical features described in the specific embodiments can be combined in any suitable manner without contradiction. For example, different embodiments and technical solutions can be formed by a combination of different specific technical features. In order to avoid unnecessary repetition, various possible combinations of various specific technical features in the present disclosure will not be described separately.

In the following description, the terms “first\second\ . . . ” are used only to distinguish different objects, and do not mean that there are similarities or relations between the objects. It should be understood that the orientation expressions “upper,” “lower,” “outer,” and “inner” are orientations in a normal use state, and may or may not be a left-right direction in the normal use state.

It should be noted that the terms “comprising,” “including” or any other variation thereof are intended to encompass a non-exclusive inclusion such that a process, method, article, or appliance that includes a series of elements includes not only those elements, but also other elements that are not explicitly listed, or elements inherent to such a process, method, article, or appliance. Without further limitation, an element defined by the phrase “comprising a . . . ” does not preclude the presence of additional identical elements in a process, method, article, or appliance comprising the element. “A plurality of” means greater than or equal to two.

In a related art, a part of a pressure limiting valve is located outside a cooking container, and a gap is present between the pressure limiting valve and the cooking container, which causes a leakage of the steam discharged through the pressure limiting valve. Although the condensed water becomes less, the leakage of the steam reduces the steam flowing to a temperature measurement device, resulting in an inaccurate temperature measurement. Alternatively, the steam discharged from the pressure limiting valve flows to the temperature measurement device through a curved exhaust chamber, and the exhaust chamber is curved. The energy loss of the steam flow is large, the steam can be in contact with a pipe wall for a longer time, and a heat exchange occurs between the hotter steam and the pipe wall, which will cause the steam to condense into condensed water, resulting in a decrease in the amount of the steam flowing from the pressure limiting valve to the temperature measurement device.

The preset direction is a direction indicated by an arrow R1.

The top-bottom direction is a direction indicated by an arrow R2.

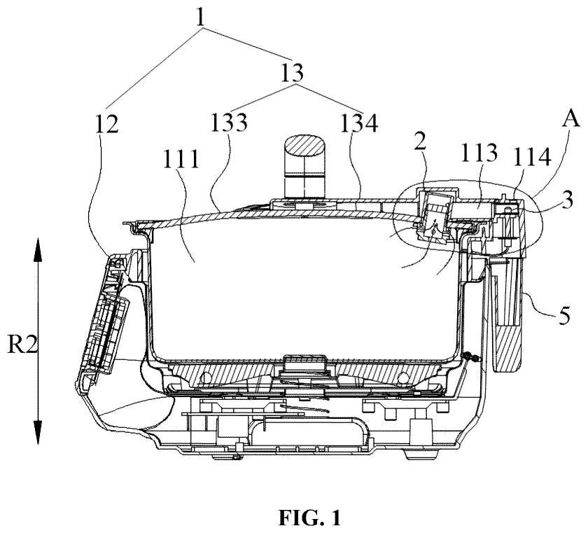

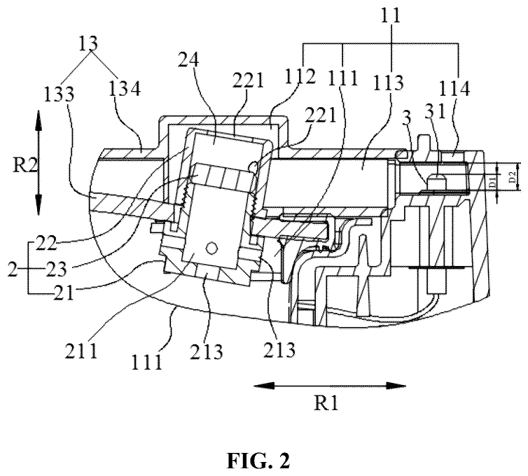

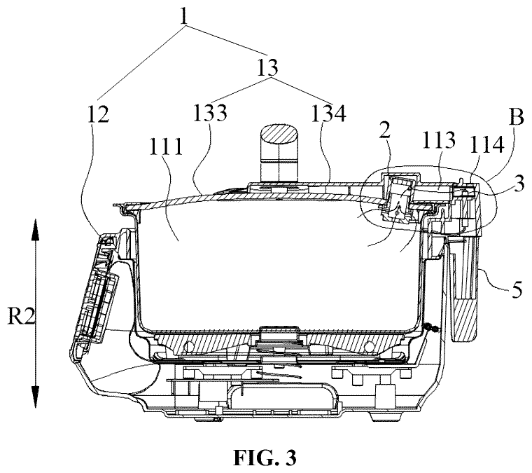

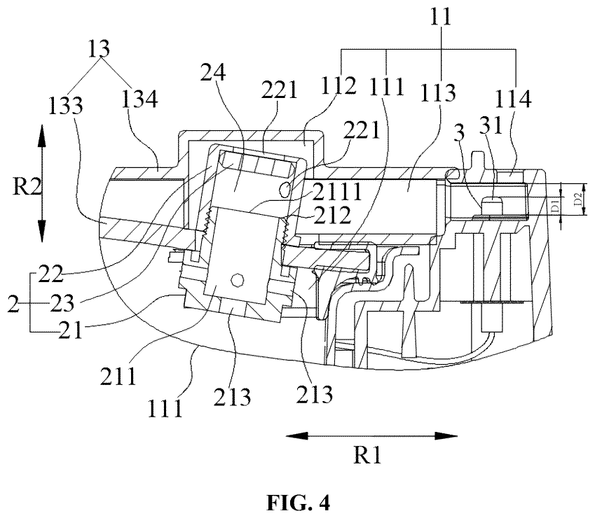

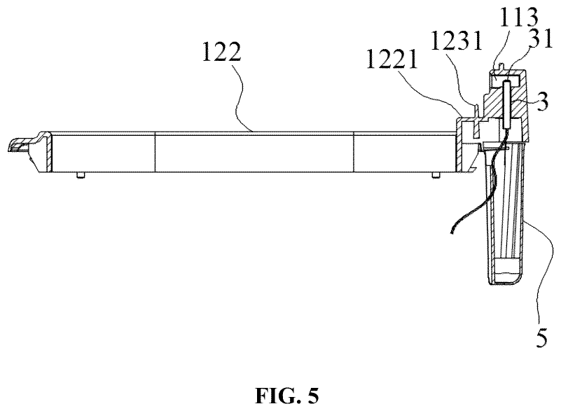

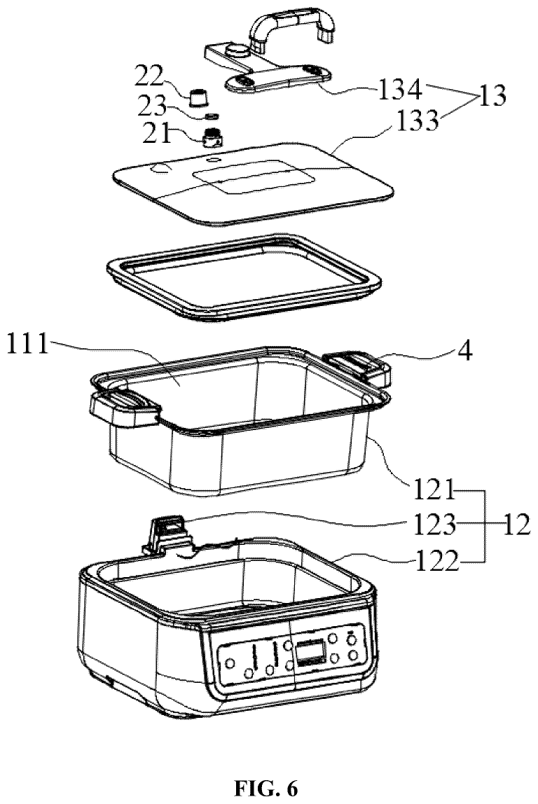

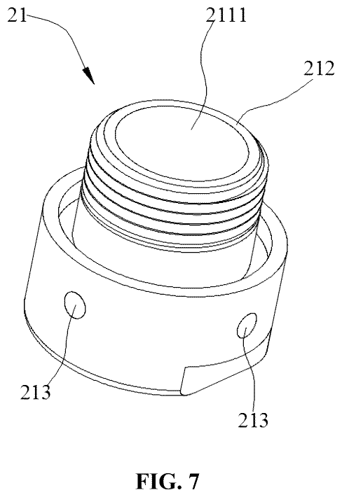

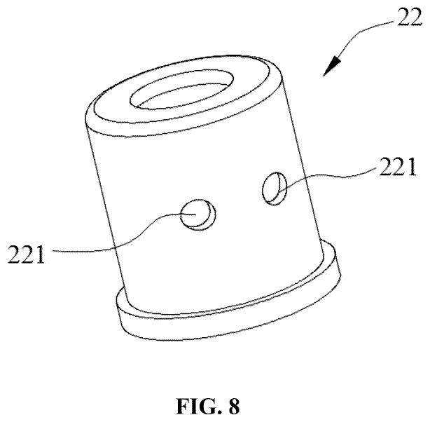

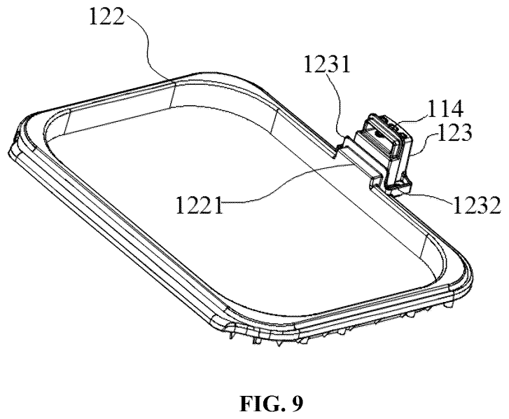

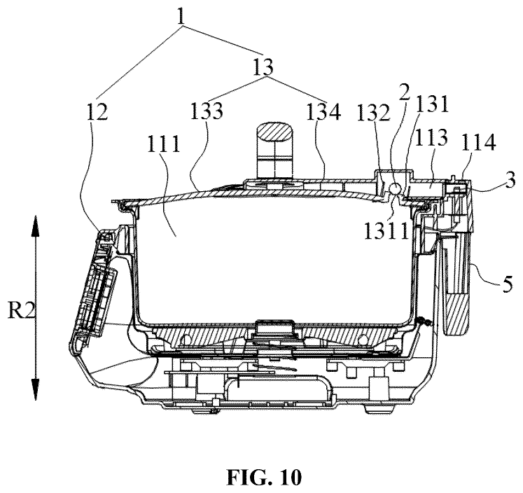

Referring to FIG. 1 to FIG. 10, a cooking appliance provided by an embodiment of the present disclosure includes a cooking container 1, a pressure limiting valve 2, and a temperature measurement device 3. The cooking container 1 is provided with a working space 11 inside the cooking container 1, the working space 11 includes a cooking chamber 111, a mounting chamber 112, an exhaust chamber 113 and an exhaust port 114, and the mounting chamber 112, the exhaust chamber 113 and the exhaust port 114 communicate with each other successively. A pressure limiting valve 2 is located in the working space 11, the pressure limiting valve 2 is at least partially located in the mounting chamber 112, and the pressure limiting valve 2 is configured to allow a communication between the mounting chamber 112 and the cooking chamber 111 or cut off a communication between the mounting chamber 112 and the cooking chamber 111. The temperature measurement device 3 is at least partially located in the exhaust chamber 113, and the fluid in the exhaust chamber 113 flows to the exhaust port 114 through the temperature measurement device 3. An arrangement direction of the pressure limiting valve 2 and the temperature measurement device 3 is a preset direction, and the exhaust chamber 113 extends from the pressure limiting valve 2 to the temperature measurement device 3 along the preset direction.

In case that a pressure in the cooking chamber 111 is greater than or equal to a pressure limiting value of the pressure limiting valve 2, the pressure limiting valve 2 is opened, and the steam in the cooking chamber 111 flows via the pressure limiting valve 2 to the exhaust port 114 through the mounting chamber 112 and the exhaust chamber 113.

In case that the pressure in the cooking chamber 111 is less than the pressure limiting value of the pressure limiting valve 2, the pressure limiting valve 2 is closed, and the steam in the cooking chamber 111 is substantially enclosed in the cooking chamber 111 by the pressure limiting valve 2.

In an example, the pressure limiting value of the pressure limiting valve 2 is less than or equal to 5 kpa.

In an example, the pressure limiting value of the pressure limiting valve 2 is less than or equal to 5 kpa, and the pressure limiting value of the pressure limiting valve 2 is greater than or equal to 1 kpa.

In the embodiment of the present disclosure, the working space 11 is located inside the cooking container 1, the pressure limiting valve 2 is located in the working space 11, and there is almost no mounting gap, communicating with the external environment, between the pressure limiting valve 2 and the cooking container 1, which reduces the leakage of the steam. In case that the pressure in the cooking chamber 111 is greater than the pressure limiting value of the pressure limiting valve 2, the steam in the cooking chamber 111 is discharged via the pressure limiting valve 2 through the mounting chamber 112, the exhaust chamber 113 and the exhaust port 114 successively. Since the temperature measurement device 3 is located in the exhaust chamber 113, the steam discharged to the exhaust port 114 via the pressure limiting valve 2 can flow through the temperature measurement device 3 located in the exhaust chamber 113 as much as possible, which facilitates the increase of the amount of the steam flowing through the temperature measurement device 3. Furthermore, the exhaust chamber 113 extends from the pressure limiting valve 2 to the temperature measurement device 3 along the preset direction, and the exhaust chamber 113 extends almost linearly, which reduces the flow resistance of the steam in the exhaust chamber 113, reduces the energy loss of the flow of the steam, reduces the contact time and heat exchange between the steam and the pipe wall, helps to suppress the formation of condensed water during the flow of the steam in the exhaust chamber 113, and increases the amount of the steam flowing to the temperature measurement device 3. Since a decrease in the amount of the stream flowing to the temperature measurement device 3 due to the leakage of the steam and the formation of the condensed water is better suppressed, the amount of the stream flowing to the temperature measurement device 3 is increased, and thus a temperature of the stream measured by the temperature measurement device 3 is more accurate.

In an embodiment, referring to FIG. 1 to FIG. 10, the temperature measurement device 3 is provided with a temperature sensing component 31 for a temperature measurement. A span of the exhaust chamber 113 along the top-bottom direction at a position corresponding to the temperature measurement device 3 is a preset distance. The temperature sensing component 31 is located in an extent from a bottom of the exhaust chamber 113 to two-thirds of the preset distance spaced apart upward from the bottom of the exhaust chamber 113.

In an example, referring to FIG. 1 to FIG. 10, the temperature sensing component 31 is located in an extent from one-third of the preset distance spaced apart upward from the bottom of the exhaust chamber 113 to two-thirds of the preset distance spaced apart upward from the bottom of the exhaust chamber 113.

In an example, referring to FIG. 1 to FIG. 10, the temperature sensing component 31 is located in an extent from the bottom of the exhaust chamber 113 to a half of the preset distance spaced apart upward from the bottom of the exhaust chamber 113.

In an example, referring to FIG. 1 to FIG. 10, the dimension D1 shown in the figures is a half of the preset distance spaced apart upward from the bottom of the exhaust chamber 113. The extent corresponding to the dimension D1 shown in the figures is an extent from the bottom of the exhaust chamber 113 to a half of the preset distance spaced apart upward from the bottom of the exhaust chamber 113.

In an example, referring to FIG. 1 to FIG. 10, the dimension D2 shown in the figures is the preset distance.

In an example, a height of the temperature sensing component 31 is not limited, and the temperature sensing component 31 may be located at any position along the top-bottom direction of the exhaust chamber 113.

In an embodiment, referring to FIG. 1 to FIG. 10, the exhaust port 114 is located downstream of the temperature measurement device 3.

In the embodiment of the present disclosure, the temperature measurement device 3 is located upstream, the exhaust port 114 is located downstream, and the steam of the exhaust chamber 113 flows through the temperature measurement device 3 and then is discharged from the exhaust port 114, which facilitates improving the accuracy of the temperature measurement of the steam.

In an example, the exhaust port 114 may be located upstream of the temperature measurement device 3.

In an embodiment, referring to FIG. 1 to FIG. 10, the cooking container 1 includes a cooking body 12 and a container lid 13. The exhaust port 114 is formed at the cooking body 12, and the temperature measurement device 3 is mounted at the cooking body 12. The container lid 13 and the cooking body 12 form the cooking chamber 111 and the exhaust chamber 113, the mounting chamber 112 is formed at the container lid 13, and the pressure limiting valve 2 is mounted at the container lid 13.

In the embodiment of the present disclosure, the temperature measurement device 3 is mounted at the cooking body 12, and the temperature measurement device 3 can be supplied with power via the body, and is not affected by the opening of the container lid 13 due to the disengagement of the container lid 13 from the cooking body 12. In this way, the container lid 13 can be relatively conveniently disengaged from the cooking body 12, and is in turn opened.

In an example, the temperature measurement device 3 may be located at the container lid 13.

In an embodiment, referring to FIG. 1 to FIG. 10, the pressure limiting valve 2 includes a valve seat 21, a valve cover 22, and a valve body 23. The valve seat 21 is at least partially located in the cooking chamber 111. The valve cover 22 is connected to the valve seat 21, the valve cover 22 is at least partially located in the mounting chamber 112, and the container lid 13 is partially clamped between the valve seat 21 and the valve cover 22. The valve body 23 is located in a space formed by the valve seat 21 and the valve cover 22, and the valve body 23 is configured to allow a communication between the mounting chamber 112 and the cooking chamber 111 or cut off a communication between the mounting chamber 112 and the cooking chamber 111.

In an example, referring to FIG. 1 to FIG. 10, the valve seat 21 and the valve cover 22 are detachably connected to each other.

In an example, referring to FIG. 1 to FIG. 10, the valve seat 21 and the valve cover 22 are screwed to each other, to allow the container lid 13 to be partially clamped between the valve seat 21 and the valve cover 22.

In an example, the steam in the cooking chamber 111 pushes the valve body 23 to move.

In an example, the shape of the valve body 23 may be in the form of a flat plate shape.

In an example, the shape of the valve body 23 may be in the form of a ball.

In an example, the valve body 23 is a hollow ball.

In the embodiment of the present disclosure, the container lid 13 is partially clamped between the valve seat 21 and the valve cover 22 via the valve seat 21 and the valve cover 22 connected to each other, to allow the pressure limiting valve 2 to be relatively firmly mounted at the container lid 13. The opening and closing of the pressure limiting valve 2 is realized by moving the valve body 23 in the space formed by the valve seat 21 and the valve cover 22.

In an embodiment, referring to FIG. 1 to FIG. 10, the valve seat 21 is provided with a first chamber 211 communicating with the cooking chamber 111, and the valve seat 21 and the valve cover 22 form a second chamber 24 communicating with the exhaust chamber 113. The valve body 23 is movably arranged in the second chamber 24, and the valve body 23 is configured to allow a communication between the first chamber 211 and the second chamber 24 or cut off a communication between the first chamber 211 and the second chamber 24.

In the embodiment of the present disclosure, the communication between the first chamber 211 and the second chamber 24 are allowed or cut off by the movement of the valve body 23 in the second chamber 24, to achieve the opening and closing of the pressure limiting valve 2.

In an example, the second chamber 24 may not be provided, the valve cover 22 partially extends into the cooking chamber 111, the valve seat 21 is arranged around the valve cover 22, and a connection port between the first chamber 211 and the cooking chamber 111 is opened or closed via the valve body 23.

In an embodiment, referring to FIG. 1 to FIG. 10, an opening of the first chamber 211 facing toward the second chamber 24 is a transition air port 2111, and the transition air port 2111 is located at a sealing end face 212 of an end of the valve seat 21 away from the cooking chamber 111. The valve seat 21 is located at a side of the sealing end face 212 away from the second chamber 24 along an arrangement direction of the first chamber 211 and the second chamber 24. The valve body 23 is located at a side of the sealing end face 212 away from the valve seat 21. The valve body 23 is configured to move into contact with the sealing end face 212 to close the transition air port 2111, and to move out of contact with the sealing end face 212 to open the transition air port 2111.

In the embodiment of the present disclosure, the valve seat 21 is located at the side of the sealing end face 212 away from the second chamber 24 along the arrangement direction of the first chamber 211 and the second chamber 24, and the valve body 23 is located at the side of the sealing end face 212 away from the valve seat 21. In this way, the entire valve body 23 is located at an end of the valve seat 21 away from the cooking chamber 111, the valve body 23 almost does not cover a side edge of the valve seat 21 laterally, and the valve body 23 can realize the opening and closing of the pressure limiting valve 2 along the arrangement direction of the first chamber 211 and the second chamber 24. Therefore, the space occupation is reduced and the space utilization rate is improved.

In an example, the valve body 23 may be arranged around the valve seat 21.

In an embodiment, referring to FIG. 1 to FIG. 10, the valve seat 21 is provided with a plurality of air inlet holes 213 communicating with the first chamber 211 and the cooking chamber 111. At least one of the plurality of air inlet holes 213 is located at a side wall of the valve seat 21. An axial direction of the at least one air inlet hole 213 located at the side wall of the valve seat 21 intersects with the arrangement direction of the first chamber 211 and the second chamber 24.

In an example, at least one of the plurality of air inlet holes 213 is located at a bottom wall of the valve seat 21.

In an example, the number of the at least one air inlet hole 213 located at the side wall of the valve seat 21 may be at least two.

In the embodiment of the present disclosure, since the direction of the air inlet hole 213 located at the side wall of the valve seat 21 does not coincide with a upward rushing direction of the liquid boiling in the cooking chamber 111, the air inlet hole 213 located at the side wall of the valve seat 21 can suppress the liquid boiling in the cooking chamber 111 from directly rushing into the first chamber 211, and facilitate preventing the liquid in the cooking chamber 111 from overflowing.

In an example, the first chamber 211 may penetrate downwardly through the valve seat 21 to communicate with the cooking chamber 111, and the valve seat 21 is not provided with a bottom wall.

In an embodiment, referring to FIG. 1 to FIG. 10, the valve cover 22 is provided with a plurality of air outlet holes 221 communicating with the second chamber 24 and the exhaust chamber 113. At least one of the plurality of air outlet holes 221 is located at a side wall of the valve cover 22. An axial direction of the at least one air outlet hole 221 located at the side wall of the valve cover 22 intersects with the arrangement direction of the first chamber 211 and the second chamber 24, and the arrangement direction of the first chamber 211 and the second chamber 24 intersects with the preset direction.

In an example, at least one of the plurality of air outlet holes 221 is located at a top wall of the valve cover 22.

In an example, the number of the at least one air outlet hole 221 located at the side wall of the valve cover 22 may be at least two.

In an example, the axial direction of the at least one air outlet hole 221 located at the side wall of the valve cover 22 is parallel to the preset direction.

In the embodiment of the present disclosure, since the direction of the air outlet hole 221 located at the side wall of the valve cover 22 does not coincide with the upward rushing direction of the liquid boiling in the cooking chamber 111, the air outlet hole 221 located at the side wall of the valve cover 22 can suppress the liquid in the first chamber 211 and the second chamber 24 from rushing out, and facilitate preventing the liquid in the cooking chamber 111 from overflowing. Further, the axial direction of the air outlet hole 221 located at the side wall of the valve cover 22 intersects with the arrangement direction of the first chamber 211 and the second chamber 24, the arrangement direction of the first chamber 211 and the second chamber 24 intersects with the preset direction, and the direction of the air outlet hole 221 located at the side wall of the valve cover 22 is close to the preset direction. Therefore, the steam discharged from the air outlet hole 221 located at the side wall of the valve cover 22 can flow to the exhaust port 114 relatively smoothly through the exhaust chamber 113.

In an embodiment, referring to FIG. 1 to FIG. 10, the cooking body 12 includes a main body 121, a shell cover 122, and a mounting seat 123. The main body 121 and the container lid 13 form the cooking chamber 111. The shell cover 122 surrounds the cooking chamber 111, is mounted at the main body 121, and is provided with a reinforcement boss 1221 located below the exhaust chamber 113. The mounting seat 123 is connected to the shell cover 122, and the mounting seat 123 at least partially protrudes from the shell cover 122. The mounting seat 123 and the container lid 13 form the exhaust chamber 113, and the exhaust port 114 is formed at the mounting seat 123. The reinforcement boss 1221 is located between the mounting seat 123 and the pressure limiting valve 2 along the preset direction. The temperature measurement device 3 is mounted at the mounting seat 123.

In the embodiment of the present disclosure, the reinforcement boss 1221 reinforces a position where the shell cover 122 is connected to the mounting seat 123 is connected, which reduces the possibility of the cracking of the shell cover 122.

In an example, the shell cover 122 and the container lid 13 may form the exhaust chamber 113, and the temperature measurement device 3 may be mounted at the shell cover 122.

In an example, the main body 121 and the container lid 13 may form the exhaust chamber 113, and the temperature measurement device 3 may be mounted at the main body 121.

In an embodiment, referring to FIG. 1 to FIG. 10, the mounting seat 123 is provided with a water blocking rib 1231 located below the exhaust chamber 113, and the water blocking rib 1231 is located between an opening of the exhaust chamber 113 on the mounting seat 123 and the pressure limiting valve 2 along the preset direction.

In the embodiment of the present disclosure, the water blocking rib 1231 blocks the condensed water, to restrict the condensed water from flowing into a gap between the shell cover 122 and the main body 121.

In an embodiment, referring to FIG. 1 to FIG. 10, the cooking container 1 further includes a lock mechanism 4 provided on the container lid 13 and/or the cooking body 12, and the lock mechanism 4 is configured to lock or unlock the container lid 13 and the cooking body 12.

In an example, referring to FIG. 1 to FIG. 10, the lock mechanism 4 is a slider movably mounted at the cooking body 12. When the container lid 13 is placed on the cooking body 12, the slider is moved to allow the slider to be partially positioned above the container lid 13 to lock the container lid 13.

In an example, referring to FIG. 1 to FIG. 10, the container lid 13 has a rectangular shape.

In the embodiment of the present disclosure, the container lid 13 is locked to the cooking body 12 via the lock mechanism 4. In this way, the cooking chamber 111 formed by the container lid 13 and the cooking body 12 can withstand cooking under a certain pressure environment, and the container lid 13 will not be pushed open by the pressure in the cooking chamber 111. The container lid 13 is locked to the cooking body 12 via the lock mechanism 4, and the container lid 13 does not need to rotate during the locking process. In this way, a portion of the container lid 13 corresponding to the exhaust chamber 113 can be better aligned with a portion of the cooking body 12 corresponding to the exhaust chamber 113, to allow the steam to be better delivered to the temperature measurement device 3.

In an embodiment, referring to FIG. 1 to FIG. 10, the temperature measurement device 3 is a temperature sensor.

In an embodiment, the temperature measurement device 3 is a temperature switch, and the temperature switch is connected in series in a heating control loop of the cooking container 1.

In the embodiment of the present disclosure, the heating control loop of the cooking container 1 can be directly turned off or turned on via the temperature switch, and the response is more rapid without passing through a signal transmission link to a controller.

In an embodiment, referring to FIG. 1 to FIG. 10, the container lid 13 is provided with a mounting boss 131 and a restraint ring 132 surrounding the mounting boss 131, the mounting boss 131 is provided with a pressure limiting port 1311, the pressure limiting valve 2 is arranged at the pressure limiting port 1311, and the restraint ring 132 restricts a radial movement of the pressure limiting valve 2 along the restraint ring 132.

In an example, the pressure limiting valve 2 is a pressure limiting plate.

In an example, the pressure limiting valve 2 is a hollow pressure limiting ball.

In the embodiment of the present disclosure, the position of the pressure limiting valve 2 along the radial direction of the restraint ring 132 is restricted by the restraint ring 132, to prevent the pressure limiting valve 2 from moving out of the position of the pressure limiting port 1311 to a certain extent after the pressure limiting valve 2 is pushed away by the steam. In this way, the pressure limiting valve 2 can be substantially maintained at the pressure limiting port 1311. In case that the pressure of the cooking chamber 111 is lower than the pressure limiting value of the pressure limiting valve 2, the pressure limiting valve 2 can fall back to the pressure limiting port 1311 to limit the pressure.

In an embodiment, referring to FIG. 1 to FIG. 10, the cooking appliance further includes a water storage box 5 mounted at a bottom of the mounting seat 123, the mounting seat 123 is provided with a water discharge passage 1232 communicating with the water storage box 5, and the water discharge passage 1232 communicating with an upper part of the mounting seat 123.

In an embodiment, referring to FIG. 1 to FIG. 10, the container lid 13 includes a lid body 133 and a flow guide casing 134, the flow guide casing 134 is connected to a side of the lid body 133 away from the cooking chamber 111. The flow guide casing 134, the lid body 133 and the cooking body 12 form the exhaust chamber 113. The flow guide casing 134 and the lid body 133 form the mounting chamber 112.

In an embodiment, referring to FIG. 1 to FIG. 10, the flow guide casing 134, the lid body 133 and the mounting seat 123 form the exhaust chamber 113.

In an embodiment, the mounting boss 131, the pressure limiting port 1311 and the restraint ring 132 are formed at the lid body 133.

In an embodiment, the diameter of the exhaust port 114 is greater than or equal to 10 mm.

In an embodiment, the cross-sectional area of the exhaust port 114 is greater than or equal to 80 mm².

In an embodiment, the cross-sectional area of the exhaust port 114 is greater than or equal to 80 mm², and the cross-sectional area of the exhaust port 114 is greater than or equal to 300 mm².

The diameter or cross-sectional area of the exhaust port 114 is larger, which facilitates the rapid exhaust of the steam from the cooking chamber.

In an embodiment, the diameter of the transition air port 2111 is greater than or equal to 10 mm.

In an embodiment, the cross-sectional area of the transition air port 2111 is greater than or equal to 80 mm².

In an embodiment, the cross-sectional area of the transition air port 2111 is greater than or equal to 80 mm², and the cross-sectional area of the transition air port 2111 is greater than or equal to 300 mm².

The diameter or cross-sectional area of the transition air port 2111 is larger, which facilitates the rapid exhaust of the steam from the cooking chamber.

In an embodiment, the diameter of the pressure limiting port 1311 is greater than or equal to 10 mm.

In an embodiment, the cross-sectional area of the pressure limiting port 1311 is greater than or equal to 80 mm².

In an embodiment, the cross-sectional area of the pressure limiting port 1311 is greater than or equal to 80 mm², and the cross-sectional area of the pressure limiting port 1311 is greater than or equal to 300 mm².

The diameter or cross-sectional area of the pressure limiting port 1311 is larger, which facilitates the rapid exhaust of the steam from the cooking chamber.

In a related art, in case that a cooking appliance is not provided with a pressure limiting valve, a cooking chamber directly communicates with the outside world through an exhaust port, steam is continuously discharged, and the moisture in the food is evaporated dry at a relatively fast speed, which is not conducive to water locking, and is difficult to better steam the food. When a pressure in the cooking appliance is too high, for example, the cooking appliance is a pressure cooker, a pressure limiting value of the corresponding pressure limiting valve is high, and when the pressure in the cooking chamber is greater than the pressure limiting value of the pressure limiting valve, the pressure limiting valve is opened, the temperature of the steam discharged from the cooking chamber is very high and substantially does not change, and an amount of water of the food in the cooking chamber cannot be determined. Therefore, it is difficult to balance both the steaming of the food and the determination of the amount of water of the food in the cooking chamber.

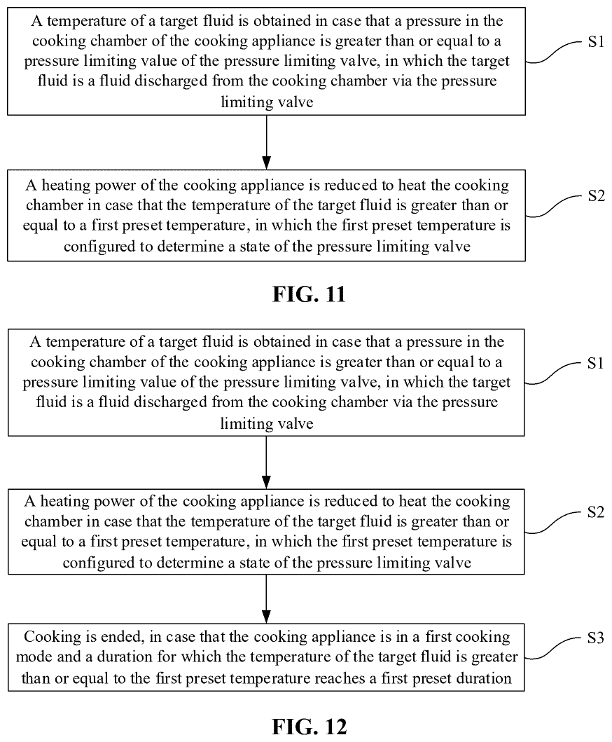

An embodiment of the present disclosure provides a method for controlling a cooking appliance, in which the cooking appliance is the cooking appliance provided according to the embodiments described above. Referring to FIG. 11, the method includes the following operations.

At operation S1, a temperature of a target fluid is obtained in case that a pressure in the cooking chamber 111 of the cooking appliance is greater than or equal to a pressure limiting value of the pressure limiting valve 2, in which the target fluid is a fluid discharged from the cooking chamber 111 via the pressure limiting valve 2.

At operation S2, a heating power of the cooking appliance is reduced to heat the cooking chamber 111 in case that the temperature of the target fluid is greater than or equal to a first preset temperature, in which the first preset temperature is configured to determine a state of the pressure limiting valve 2.

It should be noted that the first preset temperature is greater than the ambient temperature.

It should be noted that the first preset temperature is configured to determine the state of the pressure limiting valve 2, the pressure limiting valve 2 has an open state and a closed state, and the first preset temperature is the temperature of the target fluid discharged via the pressure limiting valve 2, which is measured after the pressure limiting valve 2 is switched from the closed state to the open state.

In the embodiment of the present disclosure, the cooking appliance is cooked in a micro-pressure environment, and after pressurization, the pressure in the cooking chamber 111 is small, and the target fluid discharged from the cooking chamber 111 via the pressure limiting valve 2 can still change within a large range to reflect a change in the water quantity of the food. The cooking appliance heats the food in the cooking chamber 111, and then the temperature of the target fluid increases. In case that the temperature of the target fluid reaches the first preset temperature, it can be determined that the water in the cooking chamber 111 has boiled. By measuring the temperature of the target fluid discharged via the pressure limiting valve 2, the measured temperature is not influenced by a heater inside the cooking appliance or heat conduction of a heat transfer part and can more accurately reflect the temperature of the steam in the cooking chamber 111, and the temperature of the target fluid can more accurately reflect the moisture state of the food cooked in the cooking chamber 111. In case that the temperature of the target fluid discharged via the pressure limiting valve 2 reaches the first preset temperature, the water quantity of the food is relatively sufficient, and the water in the cooking chamber 111 is in a boiling state. In this way, the power of the cooking appliance can be reduced, the temperature of the target fluid can be maintained at the first preset temperature, and accordingly the water in the cooking chamber 111 can be maintained in the boiling state. Therefore, the food can be cooked or steamed in the boiling state, and the moisture can be relieved from being evaporated too quickly. Since the cooking appliance of the present disclosure performs cooking in a micro-pressure environment and the pressure limiting valve 2 has a small pressure limiting value, the pressure limiting valve 2 can be opened to allow the temperature to be measured and the amount of water of the food to be determined after the pressure in the cooking chamber 111 reaches the pressure limiting value, and the pressure limiting valve 2 can be closed in case that the pressure in the cooking chamber 111 is less than the small pressure limiting value of the pressure limiting valve, thereby reducing the moisture loss during the food cooking.

In an example, the temperature measurement device 3 is located at a position corresponding to the exhaust port 114 outside the cooking chamber 111, and the temperature of the target fluid is measured by the temperature measurement device 3.

In the embodiment of the present disclosure, the temperature measurement device 3 is provided to measure the temperature of the target fluid discharged from the cooking chamber 111 via the pressure limiting valve 2, which can reduce the influence of the heat of the heater inside the cooking appliance and also reduce the influence of the condensed water inside the cooking appliance, and can relatively accurately reflect the temperature of the water vapor, thereby determining the moisture state of the food in the cooking chamber 111.

In an example, the target fluid is a fluid discharged from the cooking chamber 111 to an outside of the cooking appliance via the pressure limiting valve 2.

In an example, the target fluid contains water vapor.

In an example, the cooking appliance may be a rice cooker, an electric saucepan, an electric pressure cooker, or a steam oven.

It should be noted that the pressure limiting valve 2 has an open state and a closed state. In case that the pressure limiting valve 2 is in the closed state, the fluid in the cooking chamber 111 is not discharged to the outside, and the pressure in the cooking chamber 111 is greater than the outside atmospheric pressure. In case that the pressure limiting valve 2 is in the open state, the fluid in the cooking chamber 111 is discharged to the outside via the pressure limiting valve 2.

In the embodiment of the present disclosure, the pressure limiting valve 2 is provided to control the target fluid to be discharged, to allow the pressure in the cooking chamber 111 to be controlled. With the cooking process, the moisture in the cooking chamber 111 is converted into water vapor. In case that the pressure limiting valve 2 is in the closed state, it is difficult to discharge the water vapor in the cooking chamber 111, and the pressure in the cooking chamber 111 increases, which is beneficial to maintaining the moisture in the cooking chamber 111 to fully steam or cook the food, and relieving the speed of moisture evaporation.

In an embodiment, the cooking appliance includes a top heater and a bottom heater.

In the embodiment of the present disclosure, the top heater and the bottom heater can heat the cooking chamber 111 together, to allow the food in the cooking chamber 111 to be evenly heated, which reduce the situation that one side of the food is burnt and another side of the food is undercooked. Providing the top heater can reduce the condensation of the condensed water in the cooking chamber 111 and reduce the amount of the condensed water in the cooking chamber 111.

In an example, the top heater, the cooking chamber 111, and the bottom heater are arranged successively.

It is to be understood that the structure of the cooking appliance is not limited. The cooking appliance may include a bottom heater, but not include a top heater.

In an embodiment, the cooking appliance includes a top temperature measurement device and a bottom temperature measurement device.

In the embodiment of the present disclosure, the top temperature measurement device is configured to detect a temperature of the top heater, and the bottom temperature measurement device is configured to detect a temperature of the bottom heater. In this way, the temperature in the cooking chamber 111 can be more accurately controlled.

In an example, reducing the heating power of the cooking appliance means reducing the heating power of the top heater and the heating power of the bottom heater.

In an example, in case that the cooking appliance includes a bottom heater, but not includes a top heater, reducing the heating power of the cooking appliance means reducing the heating power of the bottom heater.

In an example, the boiling of water in the cooking chamber 111 may be the boiling evaporation of moisture of the food itself into water vapor or the boiling evaporation of added moisture into water vapor. For example, stewing soup requires adding water, and moisture boils and evaporates. For example, there is no need to add water in the process of roasting chicken, and the chicken is steamed by boiling the moisture of the chicken itself.

In an example, in case that the temperature of the target fluid is less than the first preset temperature, the cooking chamber 111 is heated with a first heating power, and in case that the temperature of the target fluid is greater than or equal to the first preset temperature, the cooking chamber 111 is heated with a second heating power, in which the first heating power is greater than the second heating power.

In an embodiment, the first preset temperature is greater than or equal to 50° C. and less than 100° C.

It should be noted that, in case that the temperature of the target fluid is greater than or equal to 50° C. and less than 100° C., the target fluid contains water vapor.

In the embodiment of the present disclosure, in case that the temperature of the target fluid is greater than or equal to 50° C. and less than 100° C., it may be determined that the food in the cooking chamber 111 has boiled.

In an example, the temperature of the fluid after exiting the cooking appliance is lower than the temperature of the fluid in the cooking chamber 111 in the boiling state.

In an example, the first preset temperature is 50° C., 70° C., 90° C., or 99° C.

In an embodiment, referring to FIG. 12, the method includes the following operations.

At operation S3, cooking is ended, in case that the cooking appliance is in a first cooking mode and a duration for which the temperature of the target fluid is greater than or equal to the first preset temperature reaches a first preset duration.

In an example, in the first cooking mode, the food in the cooking chamber 111 is steamed.

It should be noted that the duration for which the temperature of the target fluid is greater than or equal to the first preset temperature refers to a duration starting at a moment from when the temperature of the target fluid reaches the first preset temperature. The first preset duration is greater than 0.

In the embodiment of the present disclosure, in case that the cooking appliance is in the first cooking mode, when the temperature of the target fluid reaches the first preset temperature, it may be determined that the fluid in the cooking chamber 111 is already in the boiling state, and the fluid in the cooking chamber 111 is maintained in the boiling state to continue cooking, to allow the cooking duration to reach the first preset duration, to complete the cooking of the food.

In an example, in case that the cooking appliance is in the first cooking mode, the pressure limiting valve 2 may be in the closed state, to allow the pressure in the cooking chamber 111 to be increased, to make the food in the cooking chamber 111 more easily cooked.

In an example, in the first cooking mode, the top heater and the bottom heater together heat the cooking chamber 111.

In an embodiment, the first preset duration is greater than 0 and less than 30 min.

It should be noted that 30 min (Minute) is 30 minutes.

In the embodiment of the present disclosure, in case that the food in the cooking chamber 111 is in the boiling state, the cooking is continued for a duration greater than 0 and less than 30 minutes. In this way, the food can be cooked thoroughly, and the food can be prevented from being overcooked due to a too long cooking duration.

In an example, different first preset durations may be selected according to different food ingredients.

In an example, the first preset duration may be 10 minutes, 15 minutes, 20 minutes, or 29 minutes.

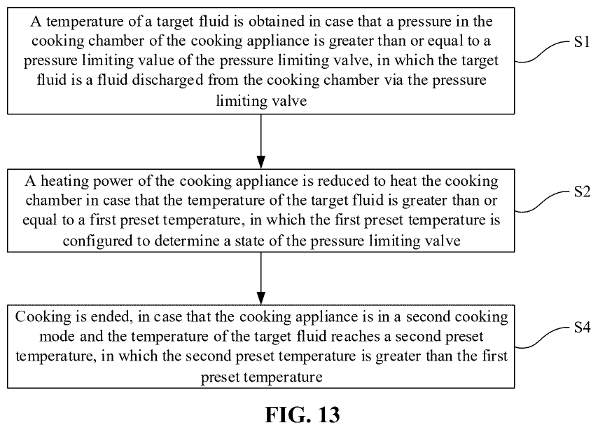

In an embodiment, referring to FIG. 13, the method includes the following operations.

At operation S4, cooking is ended, in case that the cooking appliance is in a second cooking mode and the temperature of the target fluid reaches a second preset temperature, in which the second preset temperature is greater than the first preset temperature.

In an example, in the second cooking mode, the food is steamed first, and then is reduced.

It should be noted that the first preset temperature is a temperature at which the fluid in the cooking chamber 111 is in the boiling state. As the target fluid is discharged from the cooking chamber 111, the moisture in the cooking chamber 111 decreases, the amount of the water vapor in the target fluid decreases, and the temperature of the target fluid increases. In case that the temperature of the target fluid reaches the second preset temperature, the moisture of the food in the cooking chamber 111 is substantially evaporated, and the amount of the water in the food is small, thereby achieving the purpose of reducing the food.

In the embodiment of the present disclosure, the cooking durations required for different food ingredients are different, and the cooking appliance may determine the amount of the moisture of the food ingredients in the cooking chamber 111 according to the temperature of the target fluid, and automatically adjust the cooking duration for the cooking food ingredients according to the amount of the moisture of the food ingredients.

In an example, in case that the temperature of the target fluid reaches the first preset temperature, the pressure limiting valve 2 may be in the open state, the speed at which the fluid is discharged via the pressure limiting valve 2 increases, the water dispersion in the cooking chamber 111 is accelerated, and the cooking efficiency of reducing the food is improved.

In an embodiment, the second preset temperature is greater than or equal to 100° C. and less than 150° C.

It should be noted that, in case that the temperature of the target fluid is greater than or equal to 100° C. and less than 150° C., the target fluid is mainly dry air, with a small amount of water vapor or no water vapor in the target fluid.

In the embodiment of the present disclosure, in case that the temperature of the target fluid is greater than or equal to 100° C. and less than 150° C., it may be determined that the moisture of the food in the cooking chamber 111 is substantially evaporated, and the amount of the water of the food is low.

In an example, the second preset temperature is 100° C., 120° C., 130° C., or 149° C.

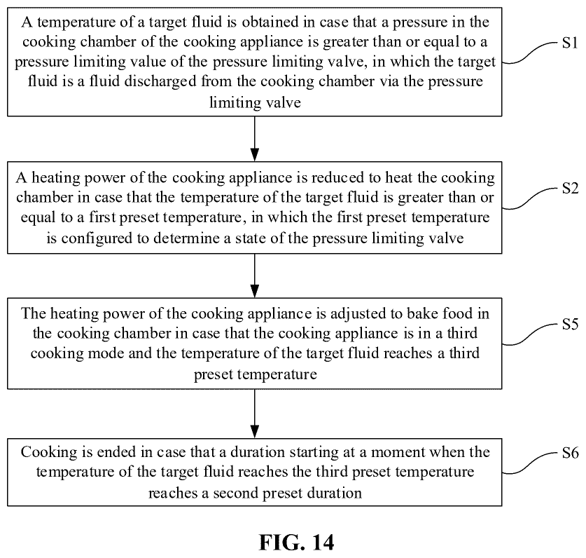

In an embodiment, referring to FIG. 14, the method includes the following operations.

At operation S5, the heating power of the cooking appliance is adjusted to bake food in the cooking chamber 111 in case that the cooking appliance is in a third cooking mode and the temperature of the target fluid reaches a third preset temperature.

At operation S6, cooking is ended in case that a duration starting at a moment when the temperature of the target fluid reaches the third preset temperature reaches a second preset duration.

In an example, in the third cooking mode, the food is first steamed to allow the food to be quickly cooked, then the water in the food is evaporated as dry as possible, and then the food is baked.

It should be noted that when the moisture in the cooking chamber 111 continues to decrease, the temperature of the target fluid continues to increase until reaching the third preset temperature, in which the third preset temperature is greater than the first preset temperature.

It should be noted that the second preset duration is greater than 0.

In the embodiment of the present disclosure, the state of the moisture of the food is recognized through the temperature of the target fluid, and corresponding cooking operations are executed to realize automatic switching of steaming, reducing, and baking.

For example, the cooking appliance uses the third cooking mode for roasting chicken, the cooking appliance heats the chicken, the moisture of the chicken (marinated chicken) itself is evaporated into steam in the closed cooking chamber, and the temperature of the target fluid is detected by the temperature measurement device 3. In case that the temperature measurement device 3 detects that the temperature of the target fluid reaches the first preset temperature, the moisture of the chicken itself in the cooking chamber 111 has boiled, and the heating power of the top heater and the heating power of the bottom heater are reduced to continue to heat the chicken, to allow the moisture in the chicken in the cooking chamber 111 to be kept in a boiling state, to steam the chicken. As the target fluid is discharged from the cooking chamber 111, after the moisture in the cooking chamber 111 becomes less, the surface of the chicken is cooked to lock the moisture inside the chicken, the amount of moisture evaporates is less, the amount of the water vapor from the target fluid is extremely small, and the temperature of the target fluid detected by the temperature measurement device 3 rises. In case that the temperature of the target fluid reaches the third preset temperature greater than the first preset temperature, the moisture on the surface of the chicken in the cooking chamber 111 is substantially evaporated, and the amount of the moisture in the chicken is less, and the heating power of the top heater and the heating power of the bottom heater are adjusted to bake the chicken. In case that the baking duration reaches the second preset duration, the cooking is ended. In the third cooking mode, the cooking appliance first steams the chicken through the moisture of the chicken itself, then determines the moisture state of the chicken in the cooking chamber 111 according to the temperature of the target fluid, and automatically controls the heating power of the cooking appliance to bake the chicken.

In an embodiment, the operation that the heating power of the cooking appliance is adjusted to bake food in the cooking chamber 111 in case that the cooking appliance is in the third cooking mode and the temperature of the target fluid reaches the third preset temperature includes the following operation.

The temperature of the target fluid is maintained at the third preset temperature to bake the food in the cooking chamber 111.

It should be noted that the expression “the temperature of the target fluid is maintained at the third preset temperature” means that the temperature of the target fluid is maintained to fluctuate within a certain range of the third preset temperature, for example, within a range of the third preset temperature±2° C.

In the embodiment of the present disclosure, the temperature of the target fluid is maintained at the third preset temperature to bake the food in the cooking chamber 111, and the temperature of the target fluid is maintained at the third preset temperature for the second preset duration. In this way, the food is baked at a higher temperature, the efficiency is improved, and the baking effect is good.

In an embodiment, the third preset temperature is greater than or equal to 100° C. and less than 150° C.

It should be noted that, after the moisture in the cooking chamber 111 is substantially evaporated, the amount of the moisture in the food is small, and a small amount of water vapor may be present in the target fluid.

In the embodiment of the present disclosure, in case that the temperature of the target fluid is greater than or equal to 100° C. and less than 150° C., the moisture of the food in the cooking chamber 111 is substantially evaporated.

In an example, the third preset temperature is 100° C., 105° C., 120° C., or 149° C.

In an embodiment, the second preset duration is greater than 0 and less than 60 minutes.

In the embodiment of the present disclosure, the moment when the temperature of the target fluid reaches the third preset temperature serves as the timing starting point, baking is started at said moment, and the baking duration is greater than 0 and less than 60 minutes. The food is baked to be fragrant, to prevent the food from being burned due to a too long baking duration.

In an example, the second preset duration may be 10 minutes, 20 minutes, 30 minutes, or 59 minutes.

In an embodiment, the operation that the heating power of the cooking appliance is adjusted to bake food in the cooking chamber 111 in case that the cooking appliance is in the third cooking mode and the temperature of the target fluid reaches the third preset temperature further includes the following operation.

The power of the top heater of the cooking appliance is increased to bake the food in the cooking chamber 111.

In the embodiment of the present disclosure, in case that the temperature of the target fluid reaches the third preset temperature (the moisture in the cooking chamber 111 is substantially evaporated), the heating power of the top heater is increased, to bake the food in the cooking chamber 111 at a high temperature, to make the food to have a crisp surface taste.

In an example, the heating power of the top heater and the heating power of the bottom heater may be different or the same.

In an example, the heating power of the cooking appliance is adjusted to bake food in the cooking chamber 111 in case that the cooking appliance is in the third cooking mode and the temperature of the target fluid reaches the third preset temperature. The power of the top heater and the power of the bottom heater of the cooking appliance are increased to maintain the temperature in the cooking chamber 111 to be greater than 100° C.

In an embodiment, in case that the cooking appliance bakes the food in the cooking chamber 111, the temperature of the top heater is a fourth preset temperature.

In the embodiment of the present disclosure, the cooking effect can be controlled by setting the heating temperature of the top heater.

In an example, in case that the cooking appliance bakes the food in the cooking chamber 111, the temperature of the bottom heater is a fourth preset temperature.

In an example, the temperature of the top heater and the temperature of the bottom heater may be different or the same.

In an embodiment, the fourth preset temperature is greater than 100° C.

In the embodiment of the present disclosure, the fourth preset temperature is greater than 100° C., and the food is baked at a high temperature, to allow the surface of the food to be baked crisp in a short duration.

In an example, the fourth preset temperature is 101° C., 120° C., 140° C., 180° C., or 200° C.

In an example, the pressure limiting value of the pressure limiting valve 2 is less than or equal to 5 kpa.

In an example, the pressure limiting value of the pressure limiting valve 2 is 1 kpa, 3 kpa or 5 kpa.

In the embodiment of the present disclosure, in case that the pressure in the cooking chamber 111 is greater than or equal to 5 kPa, the pressure limiting valve 2 is in the open state, and the fluid in the cooking chamber 111 is discharged from the cooking chamber 111 via the pressure limiting valve 2. In case that the pressure in the cooking chamber 111 is less than 5 kPa, the pressure limiting valve 2 is in the closed state, and the fluid in the cooking chamber 111 cannot be discharged.

In an example, the pressure limiting value of the pressure limiting valve 2 is not limited to 5 kPa or less. In an example, the pressure limiting value of the pressure limiting valve 2 is 6 kpa.

In some embodiments, the pressure limiting value of the pressure limiting valve 2 is less than or equal to 5 kpa and greater than or equal to 1 kpa.

In an embodiment, the diameter of an exhaust passage of the exhaust port 114 is greater than or equal to 10 mm.

In an embodiment, the cross-sectional area of an exhaust passage of the exhaust port 114 is greater than or equal to 80 mm².

In some embodiments, the cross-sectional area of the exhaust passage of the exhaust port 114 is greater than or equal to 80 mm² and less than or equal to 300 mm².

In the description of the present disclosure, an expression with reference to the terms “an embodiment,” “some embodiments,” “an example,” “a specific example,” “some examples” or the like means that specific features, structures, materials, or characteristics described in combination with the embodiment or example are included in at least one embodiment or example of the embodiments of the present disclosure. In the present disclosure, the schematic expression of the above terms is not necessarily directed to the same embodiment or example. Moreover, the specific features, structures, materials, or characteristics described may be combined with each other in any one or more embodiments or examples in a suitable manner. Furthermore, those skilled in the art can combine different embodiments or examples described in the present disclosure and features of different embodiments or examples without contradicting each other.

The foregoing merely describes some embodiments of the present disclosure, and is not intended to limit the present disclosure, and various modifications and variations can be made for those skilled in the art. Any modifications, substitutions and improvements made within the spirit and principles of the present disclosure should be included within the scope of the present disclosure.

1. A cooking appliance comprising:
a cooking container provided with a working space inside the cooking container, the working space including a cooking chamber, a mounting chamber, an exhaust chamber, and an exhaust port, and the mounting chamber, the exhaust chamber, and the exhaust port communicating with each other successively;
a pressure limiting valve located in the working space and at least partially located in the mounting chamber, the pressure limiting valve being configured to allow or cut off a communication between the mounting chamber and the cooking chamber; and
a temperature measurement device at least partially located in the exhaust chamber and configured to allow a fluid in the exhaust chamber to flow to the exhaust port through the temperature measurement device, an arrangement direction of the pressure limiting valve and the temperature measurement device being a preset direction, and the exhaust chamber extending from the pressure limiting valve to the temperature measurement device along the preset direction.

2. The cooking appliance according to claim 1, wherein the temperature measurement device is provided with a temperature sensing component for temperature measurement, a span of the exhaust chamber along a top-bottom direction at a position corresponding to the temperature measurement device is a preset distance, and the temperature sensing component is located in an extent from a bottom of the exhaust chamber to two-thirds of the preset distance spaced apart upward from the bottom of the exhaust chamber.

3. The cooking appliance according to claim 1, wherein the exhaust port is located downstream of the temperature measurement device.

4. The cooking appliance according to claim 1, wherein the cooking container includes:
a cooking body, the exhaust port being formed at the cooking body, and the temperature measurement device being mounted at the cooking body; and
a container lid, the container lid and the cooking body forming the cooking chamber and the exhaust chamber, the mounting chamber being formed at the container lid, and the pressure limiting valve being mounted at the container lid.

5. The cooking appliance according to claim 4, wherein the pressure limiting valve includes:
a valve seat at least partially located in the cooking chamber;
a valve cover connected to the valve seat and at least partially located in the mounting chamber, the container lid being partially clamped between the valve seat and the valve cover; and
a valve body located in a space formed by the valve seat and the valve cover, the valve body being configured to allow or cut off the communication between the mounting chamber and the cooking chamber.

6. The cooking appliance according to claim 5, wherein:
the valve seat is provided with a first chamber communicating with the cooking chamber, and the valve seat and the valve cover form a second chamber communicating with the exhaust chamber; and
the valve body is movably arranged in the second chamber, and is configured to allow or cut off a communication between the first chamber and the second chamber.

7. The cooking appliance according to claim 6, wherein:
an opening of the first chamber facing toward the second chamber is a transition air port located at a sealing end face of an end of the valve seat away from the cooking chamber;
the valve seat is located at a side of the sealing end face away from the second chamber along an arrangement direction of the first chamber and the second chamber;
the valve body is located at a side of the sealing end face away from the valve seat and configured to move into contact with the sealing end face to close the transition air port, and to move out of contact with the sealing end face to open the transition air port.

8. The cooking appliance according to claim 6, wherein the valve seat is provided with a plurality of air inlet holes communicating with the first chamber and the cooking chamber, at least one air inlet hole of the plurality of air inlet holes being located at a side wall of the valve seat, and an axial direction of each of the at least one air inlet hole intersecting with an arrangement direction of the first chamber and the second chamber.

9. The cooking appliance according to claim 6, wherein the valve cover is provided with a plurality of air outlet holes communicating with the second chamber and the exhaust chamber, at least one air outlet hole of the plurality of air outlet holes being located at a side wall of the valve cover, an axial direction of each of the at least one air outlet hole intersecting with an arrangement direction of the first chamber and the second chamber, and the arrangement direction of the first chamber and the second chamber intersecting with the preset direction.

10. The cooking appliance according to claim 4, wherein the cooking body includes:
a main body, the main body and the container lid forming the cooking chamber;
a shell cover surrounding the cooking chamber and mounted at the main body, the shell cover being provided with a reinforcement boss located below the exhaust chamber; and
a mounting seat connected to the shell cover and at least partially protruding from the shell cover, the mounting seat and the container lid forming the exhaust chamber, the exhaust port being formed at the mounting seat, the reinforcement boss being located between the mounting seat and the pressure limiting valve along the preset direction, and the temperature measurement device being mounted at the mounting seat.

11. The cooking appliance according to claim 10, wherein the mounting seat is provided with a water blocking rib located below the exhaust chamber, the water blocking rib being located between an opening of the exhaust chamber on the mounting seat and the pressure limiting valve along the preset direction.

12. The cooking appliance according to claim 4, wherein the cooking container further includes a lock mechanism provided on at least one of the container lid or the cooking body, the lock mechanism being configured to lock or unlock the container lid and the cooking body.

13. The cooking appliance according to claim 1, wherein the temperature measurement device includes:
a temperature sensor; or
a temperature switch connected in series in a heating control loop of the cooking container.

14. A method for controlling the cooking appliance according to claim 1, comprising:
obtaining, in response to a pressure in the cooking chamber being greater than or equal to a pressure limiting value of the pressure limiting valve, a temperature of a target fluid discharged from the cooking chamber via the pressure limiting valve; and
reducing a heating power of the cooking appliance in response to the temperature of the target fluid being greater than or equal to a preset temperature that is used to determine a state of the pressure limiting valve.

15. The method according to claim 14, wherein the preset temperature is greater than or equal to 50° C. and less than 100° C.

16. The method according to claim 14, further comprising:
ending cooking in response to the cooking appliance being in a cooking mode and a duration for which the temperature of the target fluid is greater than or equal to the preset temperature reaching a preset duration;
wherein the preset duration is greater than 0 and less than 30 minutes.

17. The method according to claim 14,
wherein the preset temperature is a first preset temperature;
the method further comprising:
ending cooking in response to the cooking appliance being in a cooking mode and the temperature of the target fluid reaching a second preset temperature greater than the first preset temperature.

18. The method according to claim 17, wherein the second preset temperature is greater than or equal to 100° C. and less than 150° C.

19. The method according to claim 14,
the preset temperature is a first preset temperature;
the method further comprising:
adjusting the heating power in response to the cooking appliance being in a cooking mode and the temperature of the target fluid reaching a second preset temperature; and
ending cooking in response to a duration starting at a moment when the temperature of the target fluid reaches the second preset temperature reaching a preset duration.

20. The method according to claim 19, wherein the second preset temperature is greater than or equal to 100° C. and less than 150° C., and the preset duration is greater than 0 and less than 60 minutes.
